(19) United States
(12) Patent Application Publication
(10) Pub. No.: US 2009/0008826 A1
(43) Pub. Date: Jan. 8, 2009

(54) Method For Production Of Objects From Thermosetting Resins

(76) Inventors: Francois Court, Paris (FR); Anthony Bonnet, Beaumont Le Roger (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/562,549

(22) PCT Filed: Jul. 2, 2003
(86) PCT No.: PCT/FR2003/002048

§ 371 Date: Sep. 22, 2008

(51) Int. Cl. C08J 5/00

(52) U.S. Cl. 264/331.13

(57) ABSTRACT

The invention relates to a formulation and a method for production of a material from an epoxy resin and a Theological control agent, which may be processed by means of the techniques for working thermoplastics yet with the capacity to react and form a thermosetting material with good shock-resistant properties.

This application claims benefit, under U.S.C. §365 of PCT/FR03/002048 filed Jul. 2, 2003.

### FIELD OF THE INVENTION

The present invention relates to the field of thermosetting resins, in particular to a formulation based on thermosetting compounds that display thermoplastic behavior and which can be processed both by the usual methods of processing of thermoplastics and are able to react to form a thermosetting material. The invention also relates to the method for producing said formulation and to the finished objects made from the latter.

### BACKGROUND OF THE INVENTION

A thermosetting material is defined as being formed from polymer chains of variable length joined together by covalent bonds so as to form a three-dimensional network. Thermosetting materials can be obtained for example by reaction of a thermosetting resin such as an epoxy with a hardener of the amine type. Thermosetting materials have many interesting properties which mean they can be used as structural adhesives or as the matrix for composites or in applications for protection of electronic components.

Epoxy materials have a high crosslink density, giving them a high glass transition temperature, Tg, which endows the material with excellent thermomechanical properties. As the crosslink density increases, the Tg of the material becomes higher, and consequently the thermomechanical properties are better and the maximum service temperature of the material is higher. Even so, they are still very difficult to use, as they are liquids prior to reaction, and cannot be manipulated.

The use and processing of epoxy resin presents problems of manipulation. The resins, which are generally fluid, cannot be stored easily and their liquid form means there is a limited number of processing routes. The use of solvent or the blending of solid and liquid resins is sometimes necessary on account of their molar mass so as to be able to reach the level of fluidity required for the application.

The applicant has just found that special formulations based on thermosetting materials and rheology-regulating agents can be shaped or processed by the usual techniques for processing thermoplastics. The finished objects thus produced have the appearance and the thermomechanical properties of thermosets.

The formulations of the invention comprise a thermosetting resin and a block copolymer having at least one block constituted mainly of methyl methacrylate units, used as a rheology-controlling agent. These materials can be made by dissolving the copolymer in the thermosetting resin, followed by addition of the hardener and hot crosslinking. The invention enables a complex object to be made from thermosetting materials without using a solvent.

### SUMMARY OF THE INVENTION

The first object of the invention is a method of production of thermosetting materials and objects based on the techniques for processing thermoplastics. This method can be described by the following stages:
a—preparation of a formulation based on thermosetting materials, by the conventional techniques such as extrusion, calendering, kneading or dissolution in a reactor
b—recovery and optional storage of the formulation prepared in a
c—production of finished objects by processing of the product obtained in b by the processing techniques that are usually restricted to thermoplastics, as are well known to a person skilled in the art.

The formulation of the invention comprises:

from 1 to 80 wt. % of the total weight of the formulation, of a rheology-regulating agent (I) comprising at least one block copolymer selected from the S-B-M, B-M and M-B-M block copolymers in which:
each block is joined to the next by a covalent bond or by an intermediate molecule joined to one of the blocks by a covalent bond and to the other block by another covalent bond,
M is a homopolymeric PMMA or a copolymer comprising at least 50 wt. % of methyl methacrylate,
B is incompatible with the thermosetting resin and with block M and its glass transition temperature Tg is below the service temperature of the thermoset,
S is incompatible with the thermosetting resin, block B and block M and its Tg or its melting point Tm is above the Tg of B,

from 20 to 99 wt. % of the total weight of the formulation, of at least one thermosetting resin (II),

from 0 to 50 wt. % of the total weight of the formulation, of at least one thermoplastic material (III).

### DETAILED DESCRIPTION OF THE INVENTION

While remaining within the scope of the invention, the formulation can contain the various organic and inorganic fillers familiar to a person skilled in the art, such as fibers, pigments, fillers, UV absorbers, fillers for improving fire resistance, etc.

The formulation of the invention displays thermoplastic behavior and can be processed by the usual techniques for processing thermoplastics, but is able to react to form a thermoset. During the reaction, said formulation can be in a perfectly liquid or rubberlike state.

Regarding the thermoset it is defined as being formed from polymer chains of variable length joined together by covalent bonds so as to form a three-dimensional network.

Examples that may be mentioned are cyanoacrylates, bismaleimides and epoxy resins crosslinked by a hardener or crosslinked by anionic or cationic polymerization.

Of the cyanoacrylates, we may mention 2-cyanoacrylic esters, which are thermosets obtained by polymerization of the monomer CH₂═C(CN)COOR with various possible groups R (without the need to add a hardener).

The thermosetting formulations of the bismaleimide type are for example:

methylenedianiline+benzophenone dianhydride+nadic imide
methylenedianiline+benzophenone dianhydride+pentylacetylene
methylenedianiline+maleic anhydride+maleimide.

Preferably the thermoset is obtained from the reaction of an epoxy thermosetting resin and a hardener. It is also defined as any product of the reaction of an oligomer bearing oxirane functions and a hardener. By means of the reactions employed during the reaction of these epoxy resins, a crosslinked material is obtained corresponding to a three-dimensional network of varying density depending on the starting characteristics of the resins and hardeners employed.

The term epoxy resin, denoted by E hereinafter, means any organic compound possessing at least two functions of the oxirane type, polymerizable by ring opening. The term “epoxy resins” denotes all the usual epoxy resins that are liquid at room temperature (23° C.) or at higher temperature. These epoxy resins can be monomeric or polymeric on the one hand, and aliphatic, cycloaliphatic, heterocyclic or aromatic on the other hand. As examples of said epoxy resins, we may mention diglycidyl ether of resorcinol, diglycidyl ether of bisphenol A, triglycidyl p-amino phenol, diglycidyl ether of bromo-bisphenol F, triglycidyl ether of m-amino phenol, tetraglycidyl methylenedianiline, triglycidyl ether of (trihydroxyphenyl) methane, polyglycidyl ethers of phenol-formaldehyde novolac, polyglycidyl ethers of orthocresol novolac and tetraglycidyl ethers of tetraphenyl ethane. Mixtures of at least two of these resins can also be used.

Epoxy resins possessing at least 1.5 oxirane functions per molecule, and more particularly epoxy resins containing between 2 and 4 oxirane functions per molecule, are preferred. Epoxy resins possessing at least one aromatic ring, such as diglycidyl ethers of bisphenol A, are also preferred.

Regarding the hardener, hardeners of epoxy resins that react at room temperature or at temperatures above room temperature are generally used as hardeners. As non-limiting examples we may mention:
Acid anhydrides, including succinic anhydride,
Aromatic or aliphatic polyamines, including diaminodiphenylsulfone (DDS) or methylenedianiline or 4,4′-methylene-bis-(3-chloro-2,6-diethylaniline) (MCDEA),
Dicyandiamide and its derivatives,
Imidazoles,
Polycarboxylic acids,
Polyphenols.

Regarding the S-B-M block copolymer, M comprises monomers of methyl methacrylate or contains at least 50 wt. % of methyl methacrylate, and preferably at least 75 wt. % of methyl methacrylate. The other monomers constituting block M may, but need not, be acrylic monomers, and may, but need not, be reactive. By reactive monomer we mean a chemical group capable of reacting with the oxirane functions of the epoxy molecules or with the chemical groups of the hardener. As non-limiting examples of reactive functions we may mention: oxirane functions, amine functions, carboxy functions etc. The reactive monomer can be (meth)acrylic acid or any other hydrolyzable monomer leading to these acids. Of the other monomers that can make up the block M, we may mention as non-limiting examples glycidyl methacrylate, tert-butyl methacrylate etc. Advantageously, M comprises PMMA that is syndiotactic to at least 60%.

Advantageously, the Tg of B is below 0° C. and preferably below −40° C.

The monomer used for synthesis of the elastomeric block B can be a diene selected from butadiene, isoprene, 2,3-dimethyl-1,3-butadiene, 1,3-pentadiene, and 2-phenyl-1,3-butadiene. B is selected advantageously from the poly(dienes), notably poly(butadiene), poly(isoprene) and their random copolymers, or from the partially or fully hydrogenated poly(dienes). Of the polybutadienes, it is advantageous to use those with the lowest Tg, for example polybutadiene-1,4 with Tg (around −90° C.) lower than that of polybutadiene-1,2 (around 0° C.). Blocks B can also be hydrogenated. This hydrogenation is carried out by the usual methods.

The monomer used for synthesis of the elastomeric block B can also be an alkyl (meth)acrylate, and the following Tg values are obtained given in parentheses following the name of the acrylate: ethyl acrylate (−24° C.), butyl acrylate (−54° C.), 2-ethylhexyl acrylate (−85° C.), hydroxyethyl acrylate (−15° C.) and 2-ethylhexyl methacrylate (−10° C.). Use of butyl acrylate is advantageous. The acrylates are different from those of block M, to comply with the condition that B and M are incompatible.

Preferably, blocks B mainly comprise polybutadiene-1,4.

The Tg or the Tm of S is advantageously above 23° C. and preferably above 50° C. As examples of blocks S, we may mention those derived from aromatic vinyl compounds such as styrene, α-methylstyrene, vinyltoluene, and those derived from alkyl esters of acrylic and/or methacrylic acids having from 1 to 18 carbon atoms in the alkyl chain. In this last-mentioned case the acrylates are different from those of block M to comply with the condition that S and M are incompatible.

The S-B-M triblock has a number-average molecular weight between 10000 g/mol and 500000 g/mol, preferably between 20000 and 200000 g/mol. Advantageously, the S-B-M triblock has the following composition expressed as mass fraction, the total being 100%:

M: between 10 and 80% and preferably between 15 and 70%.
B: between 2 and 80% and preferably between 5 and 70%.
S: between 10 and 88% and preferably between 15 and 85%.

The block copolymers used in the materials of the present invention can be made by anionic polymerization, for example by the methods described in patent applications EP 524,054 and EP 749,987.

Advantageously, the proportion of impact modifier is from 10 to 60% for 90 to 40% of thermosetting resin respectively.

Regarding the S-B diblock the S and B blocks are incompatible and they comprise the same monomers and optionally comonomers as the S blocks and the B blocks of the S-B-M triblock. The S and B blocks can be identical or different from the other S and B blocks present in the other block copolymers of the impact modifier in the thermoset.

The S-B diblock has a number-average molecular weight between 10000 g/mol and 500000 g/mol, preferably between 20000 and 200000 g/mol. The S-B diblock advantageously comprises a mass fraction of B between 5 and 95% and preferably between 5 and 60%.

According to a preferred embodiment of the invention the rheology-regulating agent comprises at least one S-B-M block copolymer and at least one S-B block copolymer. Advantageously it comprises between 5 and 80% of S-B diblock for 95 to 20% respectively of S-B-M triblock.

Moreover, the advantage of these compositions is that it is not necessary to purify the S-B-M after it has been synthesized. In fact the S-B-M are generally prepared starting from S-B and the reaction often leads to a mixture of S-B and S-B-M which is then separated to obtain the S-B-M.

According to an advantageous embodiment, a portion of the S-B-M can be replaced with an S-B diblock. This portion can be up to 70 wt. % of the S-B-M.

We would still remain within the scope of the invention if all or part of the S-B-M triblock were replaced with an M-S-B-S-M or M-B-S-B-M pentablock. They can be prepared by anionic polymerization, like the diblocks or triblocks mentioned above, but using a bifunctional initiator. The number-average molecular weight of these pentablocks is within the same ranges as that of the S-B-M triblocks. The proportion of the two M blocks together, and of the two B or S blocks together is in the same ranges as the proportions of S, B and M in the S-B-M triblock.

The formulations of the invention can be prepared by mixing thermosetting resin that has not yet been crosslinked, using a conventional mixing device. It will be possible to use all of the thermoplastic techniques that provide homogeneous mixing of the thermosetting resin and the regulating agent such as extrusion, calendering, injection molding or pressing. The product obtained can be in the form of granules, sheet or film. The unreacted or partially reacted material thus obtained can thus be in the form of a rubbery material that can be manipulated. Said processing will be carried out at a temperature providing slow kinetics of reaction of the thermosetting material. In stage [c], in the course of processing in the form of finished object and merely by increasing the temperature, the thermosetting resin will be converted to a thermoset. During the temperature rise, the rubbery material undergoing reaction can, depending on the nature of the resin (II) and of the agent (I) used, change back to the liquid state or remain in the rubbery state.

It is obvious that this invention can be applied to a liquid reactive resin capable of forming, after reaction, a linear or branched polymer displaying thermoplastic behavior. This approach can be applied successfully for example to acrylic resin while remaining within the scope of the invention.

The finished objects of the invention can be used in various branches of industry. By way of illustration, as a non-limiting example, we may mention application in the manufacture of high-pressure, high-temperature tubes, which can be made by extrusion of DGEBA-MDEA blend with 50% of S-B-M at 150° C. followed by shaping at the desired temperature and crosslinking by raising the temperature, though without exceeding the temperature at which liquefaction of the formulation occurs.

This resin can also be used in the form of film with thickness less than 100 μm or sheet, produced by extrusion coating, cast extrusion or by calendering. Said extrusion will be carried out at a temperature that prevents excessive progression of the reaction, then said film or sheet can be bonded to a substrate and finally crosslinked by raising the temperature or simply by storing at a temperature at which the reaction kinetics is slow, for example 0° C.

The experimental section described hereunder illustrates the invention without limiting its scope.

### EXAMPLES

### Curing Conditions

The usual conditions are employed.

Addition of the usual additives to the formulation, e.g. thermoplastics such as polyether sulfones, polysulfones, polyether imides, polyphenylene ethers etc., would remain within the scope of the invention.

The following products were used:

Epoxy resin: diglycidyl ether of bisphenol A (DGEBA) of molecular weight 383 g/mol with an average number of hydroxyl groups per epoxy group of n=0.075, marketed by the company Ciba Geigy with the trade designation LY556.

Hardener: an amine hardener, namely an aromatic diamine, 4,4′-methylene-bis-(3-chloro-2,6-diethylaniline), marketed by the company Lonza under the trade designation LONZACURE M-DEA. This product is characterized by a melting point between 87° C. and 90° C. and a molecular weight of 310 g/mol.

SBM1: this is an S-B-M triblock copolymer in which S is polystyrene, B is polybutadiene and M is PMMA containing a mass fraction of 22% of polystyrene, a mass fraction of 9% of polybutadiene and 69 wt. % of poly(methyl methacrylate), obtained by successive anionic polymerization of a polystyrene block with number-average molecular weight of 7000 g/mol, a polybutadiene block with molecular weight of 11000 g/mol and a poly(methyl methacrylate) block with number-average molecular weight of 84000 g/mol. This product was made following the procedure described in EP 524,054 and in EP 749,987. This product has three glass transitions, one at −90° C., another at 95° C. and a third at 130° C.

SBM2: this is an S-B-M triblock copolymer in which S is polystyrene, B is polybutadiene and M is PMMA containing a mass fraction of 12% of polystyrene, a mass fraction of 18% of polybutadiene and 70 wt. % of poly(methyl methacrylate), obtained by successive anionic polymerization of a polystyrene block with number-average molecular weight of 14000 g/mol, a polybutadiene block with molecular weight of 22000 g/mol and a poly(methyl methacrylate) block with number-average molecular weight of 85000 g/mol. This product was prepared following the procedure described in EP 524,054 and in EP 749,987. This product has three glass transitions, one at −90° C., another at 95° C. and a third at 130° C.

### Production of Mixtures Containing Another Type of Regulating Agent Such as Core-Shell or SBS.

The core-shell particles are dispersed in DGEBA using a calender. The cycles comprise 10 minutes of mixing followed by 10 minutes of rest. The mixture is then heated to 100° C. (above the melting point of the amine) and the diamine is dispersed for a period of 10 minutes.

### Curing Conditions:

The mixtures are cured for 2 hours at 220° C.

### Measurement of the Glass Transition Temperature Tg by Thermomechanical Analysis:

Tg was measured by dynamic-mechanical analysis on post-cured samples using a Rheometrics instrument (Rheometrics Solid Analyzer RSAII). The samples of parallelepiped shape (1*2.5*34 mm3) are submitted to temperature scanning between 50 and 250° C. at a tension frequency of 1 Hz. The glass transition temperature is recorded at the maximum of tan d.

### Measurement of Swelling:

A sample of parallelepiped shape with dimensions 20×20×1 mm is placed in a 100 ml beaker filled with toluene for a period of 15 days. The beaker is kept hermetically sealed, at room temperature. After 15 days of immersion the sample is taken out and its weight is checked. The percentage swelling is obtained from the following equation:

% swelling=(m_{15days}−mᵢₙᵢₜᵢₐₗ)/mᵢₙᵢₜᵢₐₗ

The sample is then dried and weighed again to check that none of the constituents of the material was dissolved by the toluene.

### Example 1

### According to the Invention

A roller mixer is charged with 40 g of SBM of composition 203050 and with number-average molecular weight of the PS block of 7000 g/mol plus 60 g of DGEBA epoxide mixture DER3320 from the company DOW Chemicals with molecular weight of 348.5 g/mol and MDEA amine from the company Lonza. The DGEBA and the MDEA are added to the mixture in stoichiometric proportions i.e. 41.53 g of DGEBA and 18.47 g of MDEA. Mixing is carried out at 150° C. This mixture is first pressed to the form of a transparent plate 1 mm thick, which has elongation at break in tension of 650% and glass transition temperature of 0° C. This mixture is then cured at 220° C. for 2 h. The mixture has a liquefaction temperature of 150° C. The glass transition temperature of the plate obtained is 154° C. and no swelling in toluene is observed.

### Example 2

### According to the Invention

A roller mixer is charged with 40 g of SBM of composition 203050 and with number-average molecular weight of the PS block of 25000 g/mol plus 60 g of DGEBA epoxide mixture DER3320 from the company DOW Chemicals with molecular weight of 348.5 g/mol and MDEA amine. The DGEBA and the MDEA are added to the mixture in stoichiometric proportions i.e. 41.53 g of DGEBA and 18.47 g of MDEA. Mixing is carried out at 150° C. This mixture is first pressed to the form of a transparent plate 1 mm thick, which has elongation at break in tension of 700% and glass transition temperature of 0° C. This mixture is then cured at 220° C. for 2 h. The mixture has a liquefaction temperature of 230° C. The glass transition temperature of the plate obtained is 155° C. and no swelling in toluene is observed.

### Example 3

### According to the Invention

A roller mixer is charged with 30 g of SBM of composition 203050 and with number-average molecular weight of the PS block of 7000 g/mol, 10 g of PPO® Blendex 803 from the company General Electric plus 60 g of DGEBA epoxide mixture DER332® from the company DOW Chemicals with molecular weight of 348.5 g/mol and MDEA amine. The DGEBA and the MDEA are added to the mixture in stoichiometric proportions i.e. 41.53 g of DGEBA and 18.47 g of MDEA. Mixing is carried out at 150° C. This mixture is first pressed to the form of a transparent plate 1 mm thick, which has elongation at break in tension of 620% and glass transition temperature of 0° C. This mixture is then cured at 220° C. for 2 h. The mixture has a liquefaction temperature of 230° C. The glass transition temperature of the plate obtained is 158° C. and no swelling in toluene is observed.

### Example 4

### Comparative

A roller mixer is charged with 40 g of SBS block copolymer and 60 g of DGEBA epoxide mixture DER332® from the company DOW Chemicals with molecular weight of 348.5 g/mol and MDEA amine. The DGEBA and the MDEA are added to the mixture in stoichiometric proportions i.e. 41.53 g of DGEBA and 18.47 g of MDEA. The mixture obtained on cooling is opaque, macroseparated and does not display any cohesion.

### Example 5

### Comparative

A roller mixer is charged with 40 g of core shell of the Paraloid KM355® type, said core-shell particle possessing a core consisting mainly of butyl acrylate and a shell of poly(methyl methacrylate), and 60 g of DGEBA epoxide mixture DER332® from the company DOW Chemicals with molecular weight of 348.5 g/mol and MDEA amine. The DGEBA and the MDEA are added to the mixture in stoichiometric proportions i.e. 41.53 g of DGEBA and 18.47 g of MDEA. The mixture obtained on cooling is translucent and does not display any cohesion.

1. A method of production of objects from thermosetting resin comprising following stages:
a—preparing a formulation based on thermosetting materials;
b—recovering and optionally storing the prepared formulation; and
c—producing finished objects by processing of the product obtained in step (b) by the processing techniques that are usually restricted to thermoplastics.

2. The method as claimed in claim 1, wherein a formulation is prepared by extrusion, calendering or dissolution in a reactor, said formulation comprising:
from 1 to 80 wt. % of the total weight of the formulation, of a rheology-regulating agent (I) comprising at least one block copolymer selected from the S-B-M, B-M and M-B-M block copolymers in which:
each block is joined to the next by a covalent bond or by an intermediate molecule joined to one of the blocks by a covalent bond and to the other block by another covalent bond,
M is a homopolymeric PMMA or a copolymer comprising at least 50 wt. % of methyl methacrylate,
B is incompatible with the thermosetting resin and with block M and its glass transition temperature Tg is below the service temperature of the thermoset,
S is incompatible with the thermosetting resin, block B and block M and its Tg or its melting point Tm is above the Tg of B,
from 20 to 99 wt. % of the total weight of the formulation, of at least one thermosetting material (II),
from 0 to 50 wt. % of the total weight of the formulation, of at least one thermoplastic material (III),
wherein the formulation can optionally comprise organic and inorganic fillers selected from the group consisting of fibers, pigments, UV absorbers and fillers for improving fire resistance.

3. The method as claimed in claim 2, wherein in the course of stage (a) the thermosetting material (II) is mixed with the agent (I) in processing conditions with slow reaction kinetics of (II), then in a second stage in which reaction is initiated by raising the temperature or by any other means.

4. The method as claimed in claim 2, wherein the M blocks of the block copolymers comprise PMMA that is at least 60% syndiotactic.

5. The method as claimed in claim 2, wherein the M blocks of the block copolymers comprise reactive one or more monomers, selected from the group consisting of glycidyl methacrylate, tert-butyl methacrylate and acrylic acid.

6. The method as claimed in claim 2, wherein the Tg of the B blocks of the block copolymers is below 0° C.

7. The method as claimed in claim 2, wherein the B blocks of the block copolymers are mainly comprised of polybutadiene-1,4.

8. The method as claimed in claim 2, wherein the dienes of the B block are hydrogenated.

9. The method as claimed in claim 2, wherein the B block comprises poly(butyl acrylate).

10. The method as claimed in claim 2, wherein the Tg or the Tm of S is above 23° C.

11. The method as claimed in claim 2, wherein S is polystyrene.

12. The method as claimed in claim 2, wherein the number-average molecular weight of the block copolymers is between 10000 g/mol and 500000 g/mol.

13. The method as claimed in claim 2, wherein the number-average molecular weight of the block copolymers is between 20000 g/mol and 200000 g/mol.

14. The method as claimed in claim 2, wherein the proportion of agent (I) is from 1 to 35% for respectively 99 to 65% of (II).

15. The method as claimed in claim 2, wherein the regulating agent (I) comprises at least one of the block copolymers M-B-M, S-B-M and at least one polymer selected from core-shells (A), functionalized elastomers, S-B block copolymers and ATBN or CTBN reactive rubbers.

16. The method as claimed in claim 2, wherein the B of the S-B diblock is selected from the group consisting of polybutadiene-1,4, denes that are hydrogenated, and poly(butyl acrylate), and the S of the S-B diblock is selected from the group consisting of an S having a Tg or a Tm of above 23° C., and polystyrene.

17. The method as claimed in claim 16, wherein the S-B diblock has a number-average molecular weight between 10000 g/mol and 500000 g/mol.

18. The method as claimed in claim 2, wherein the impact modifier comprises at least one S-B-M block copolymer and at least one S-B block copolymer.

19. The method as claimed in claim 2, wherein the impact modifier comprises at least one S-B-M block copolymer and at least one core-shell polymer (A).

20. The method as claimed in claim 2, wherein the impact modifier comprises at least one S-B-M block copolymer, at least one ATBN or CTBN reactive rubber and optionally an S-B block copolymer.

21. The method as claimed in claim 2, wherein all or part of the S-B-M triblock is replaced with an M-S-B-S-M or M-B-S-B-M pentablock.

22. The method as claimed in claim 2, wherein the thermosetting resin is a thermosetting epoxy resin and a hardener.

23. The method as claimed in claim 1, wherein the product obtained in b is in the form of granules.

24. The method as claimed in claim 23, wherein the granules are stored without time limitation.

25. The method as claimed in claim 1, wherein the product obtained in b is in the form of sheet.

26. The method as claimed in claim 1, wherein the product obtained in b is in the form of film.

27. The method as claimed in claim 27, wherein the sheet or film is stored without time limitation at a temperature below 0° C.

28. (canceled)

29. (canceled)

30. (canceled)

31. (canceled)

32. (canceled)

33. (canceled)

34. (canceled)

35. (canceled)

36. A finished object, produced by the method of claim 1 comprising a tube, a plate, a sheet, or a film.

37. The finished object, produced by the method of claim 1 comprising a tube for high-pressure or high-temperature applications, a plate for use in thermoforming a part for use in the automobile industry, a sheet for use in electrical or electronic applications, or a film for use in coating applications.
